(19) United States
(12) Patent Application Publication
(10) Pub. No.: US 2025/0206539 A1
(43) Pub. Date: Jun. 26, 2025

(54) METHOD OF ENHANCING EFFICIENCY OF GEOMECHANICAL ENERGY STORAGE SYSTEMS

(71) Applicant: Halliburton Energy Services, Inc., Houston, TX (US)

(72) Inventors: Ryan W. McChesney, Carrollton, TX (US); Stephen Michael Greci, Carrollton, TX (US)

(21) Appl. No.: 18/394,361

(22) Filed: Dec. 22, 2023

(51) Int. Cl. B65G 5/00; F02C 1/02

(52) U.S. Cl. CPC B65G 5/00; F02C 1/02; F05D 2220/76

(57) ABSTRACT

Some implementations include a system configured for subsurface energy storage, the system comprising: at least a first wellbore drilled into one or more subsurface formations; a first downhole accumulator having a first fluid; and a first subsurface storage zone including a second fluid and the first downhole accumulator.

### FIELD

Some implementations relate generally to energy storage, and more particularly, to the field of energy storage via fluid injection into one or more subsurface formations.

### BACKGROUND

Energy storage applications may be utilized to store power for later use. Grid-scale renewable power sources such as wind farms, solar farms, etc. may store excess power in the form of chemical storage (batteries), mechanical storage (pumped hydroelectric, flywheels, etc.), thermal storage, etc. A subset of mechanical energy storage, geomechanical energy storage systems may utilize hydraulic fracturing to create one or more subsurface formations, reservoirs, etc. for storing energy. The formations may be hydraulically fractured, and when power prices are low, the formations may be injected with water which may be stored at pressure indefinitely. When power prices are higher, the water injected into the storage formation may be produced through a hydroelectric turbine system, discharging the mechanical “battery” formed by the storage formations.

Typical geomechanical energy storage systems may utilize a single zone storage system within one or more subsurface formations, cavernous regions, etc. to store pumped fluid. The injected fluid may elastically deform the storage zone and expand the rock against as the storage formation is pressurized. This may build potential energy as the pressurized fluid resists overburden stresses. Energy stored in this fashion may be recovered by producing the fluid within the storage formation as the elastically-deformed rock relaxes to its original position. The stored mechanical energy may be recovered by producing the pressurized fluid within the storage formation through a turbine. The process of injecting fluids to pressurize the storage formation and producing the fluids to generate power may be repeated a number of times.

Traditional approaches to geomechanical energy storage may be limited to use in conjunction with salt caverns, may use a single zone for storage, may rely purely on the elastic strain energy of the formation to drive production, may not utilize inflow control devices to manage fluid flow, etc. These traditional approaches have their limitations. For example, using a single zone may render the storage system prone to instability and leakage after repeated pressurization and depressurization cycles. Thus, a new approach may avoid damage to the storage formation after repeated injection and production cycles by compartmentalizing one or more cells within the storage formation. This new approach may also generate and employ an artificial gas cap to improve the energy storage capability of the geomechanical energy storage system.

### BRIEF DESCRIPTION OF THE DRAWINGS

Implementation of the disclosure may be better understood by referencing the accompanying drawings.

FIG. 1 is an illustration depicting an example geomechanical energy storage system, according to some implementations.

FIG. 2 is a block diagram depicting an example computer, according to some implementations.

FIG. 3 is a flowchart of an example method for geomechanical energy storage using at least one wellbore, according to some implementations.

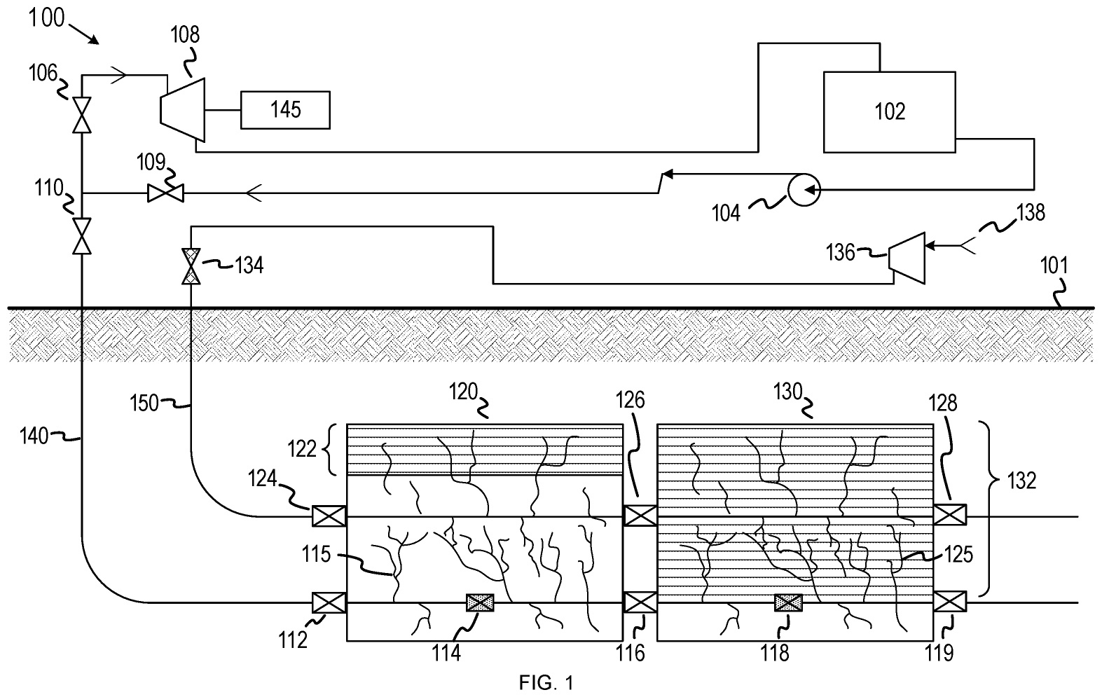

FIGS. 1-3 and the operations described herein are examples meant to aid in understanding example implementations and should not be used to limit the potential implementations or limit the scope of the claims. None of the implementations described herein may be performed exclusively in the human mind nor exclusively using pencil and paper. None of the implementations described herein may be performed without computerized components such as those described herein. Some implementations may perform additional operations, fewer operations, operations in parallel or in a different order, and some operations differently.

### Overview

To overcome the limitations of traditional geomechanical energy storage systems, one or more wellbores may be used to create a multizone geomechanical pumped energy storage system downhole. A first wellbore may be drilled into one or more storage formations to create a storage zone. A plurality of storage zones may be hydraulically fractured and used for geomechanical energy storage. After fracturing the storage formation(s), atmospheric air and/or other gases may be injected, either through the first wellbore or through a second wellbore dedicated to gas injection, to create an artificial gas cap in each of the plurality of storage zones. In the configuration where two wellbores are used, water may be injected into each storage zone from a lower wellbore.

Electrical power, either when produced in excess or at a lower price point, may be used to run one or more injection pumps and equipment used to inject fluid. When power prices are suitably higher than, a single storage zone or all storage zones may be produced to reclaim the stored power at the higher price. The water within each storage zone may be displaced by the expansion of the gas cap during production. Following gas breakthrough in a storage zone, production may be halted or choked by an inflow control device comprising an inflow control valve, an interval control valve, an electronic inflow control device (EICD), a downhole autonomous inflow control device (DAICD), etc. The use of inflow control devices for each storage zone may grant the ability to isolate any storage zones that are losing pressure or are no longer able to maintain pressurization. Thus, potential problems within the geomechanical storage system may be isolated, and new storage zones may be created to compensate for underperforming zones.

The description that follows includes example systems, methods, techniques, and program flows that embody aspects of the disclosure. However, it is understood that this disclosure may be practiced without these specific details. For instance, this disclosure refers to geomechanical energy storage in one or more subsurface formations. Aspects of this disclosure may also be applied to any other configuration of devices configured to perform related operations. While depicted for a land-based well system, example implementations may be used in subsea operations that employ floating or sea-based platforms and rigs. For clarity, some well-known instruction instances, protocols, structures, and techniques have been omitted.

### Example Energy Storage System

FIG. 1 depicts an example geomechanical energy storage system 100, according to some implementations. The geomechanical energy storage system 100 includes a first wellbore 140 and a second wellbore 150 coupled with various equipment above and below the surface 101. A storage vessel 102 may be configured to store water or any other working fluid prior to injection. When power prices are low, energy may be stored using the geomechanical energy storage system 100. Fluid may be injected into the subsurface during lower power prices and produced at the surface 101 when power prices are higher. During an injection cycle to store energy, a working fluid may be pumped from the storage vessel 102 through an injection pump 104. In some implementations this may be a water injection pump, although other pump configurations may be used. Electrical power at the lower power price may be used to run the injection pump 104. The fluid is output from the injection pump 104 at an increased rate and pressure. After passing through a valve 109, output flow from the injection pump 104 may flow through a valve 110 in an open state and is injected into the first wellbore 140. During the injection cycle, the valves 109 and 110 are open, while a valve 106 remains closed. The first wellbore 140 and second wellbore 150 are depicted as horizontal wells, but vertical wellbores, a combination of vertical and horizontal wellbores, or any other well configuration may also be used. The first wellbore 140 may also be referred to as the injector/producer well. The first wellbore 140 and second wellbore 150 may be cased or non-cased wells including a tubing string or any other suitable conduit for injection and production operations.

Injected fluid travels through tubing of the first wellbore 140, through a packer 112, and into a storage zone 120. The storage zone 120 may be partly bound by the packer 112 on one end and a packer 116 at the other end. The storage zone 120 may typically include one or more impermeable, non-hydrocarbon-bearing reservoirs (e.g., one or more shale formations), although other types of subsurface formations may be used. In some implementations, the storage zone 120 may include fractures 115 created via hydraulic fracturing by which the injected fluid may flow into the storage zone 120. Other implementations may use more permeable formations which may not require the fractures 115 to propagate injected fluid through the storage zone 120. The second wellbore 150 may also be encompassed, at least in part, by the storage zone 120. The portion of the second wellbore 150 that is encompassed by the storage zone 120 is bounded by a packer 124 and a packer 126.

In some implementations, the second wellbore 150 may be coupled to an atmospheric air intake 138. The atmospheric air intake 138 may be configured to intake air at ambient conditions that may then be compressed via a compressor 136. The compressed air travels through a flow line from the compressor 136 to a gas injector 134. In other implementations, other types of gases (nitrogen, carbon dioxide, natural gas, etc.) may be sourced, compressed via the compressor 136, and injected down the second wellbore 150. The gas injector 134 may be a valve including an injector body and nozzle, although other configurations may be used. Gas may be injected into the second wellbore via the gas injector 134. The gas may travel along the second wellbore 150 into the storage zone 120 via the fractures 115, forming an artificial gas cap 122. In some implementations, gas injection operations to form the gas cap 122 may also occur during lower power prices, although the gas injection may occur as needed to maintain the pressurization of the gas cap 122. In other implementations, gas injection may be periodic to maintain pressurization of the gas cap 122, although this may not be required. The fractures 115 between the first wellbore 140 and the second wellbore 150 may be in hydraulic communication to allow the gas cap 122 to interact with the injected incompressible fluid in the storage zone 120. Similarly, the fractures 125 may allow for hydraulic communication across the storage zone 130 (i.e., between the first wellbore 140 and the second wellbore 150) so gas cap 132 may interact with injected fluid in the storage zone 130.

The gas cap 122 may include a compressible fluid (e.g., a gas) while the remainder of the storage zone 120 may include an incompressible fluid such as water input via the first wellbore 140. When power prices are low (although injection may occur at any time), water may be injected into the storage zone 120 via the first wellbore 140. The water may deform the formation(s) comprising the storage zone 120. At higher prices, the water may be produced to the surface 101 via the first wellbore 140. This production cycle is depicted by the storage zone 130 which is shown as a partially-discharged storage zone.

The storage zone 130 is a storage zone similar to the storage zone 120. The storage zone 130 is bound by packers 116 and 119 of the first wellbore 140 and packers 126 and 128 of the second wellbore 150. The storage zone 130, as depicted, may be at least partially discharged of incompressible fluid. The storage zone 120 depicts an injection scenario for storing energy while the storage zone 130 depicts a production scenario used to produce electricity at the surface. However, both the storage zone 120 and storage zone 130 may be used to store fluid during an injection cycle and may both be produced during a production cycle for power generation. In some implementations, a plurality of storage zones (two or more) may be created. Some storage zones may be injected with an incompressible fluid during an injection cycle while others remain shut-in via the ICDs 114, 118. Vice versa, some of the storage zones may be opened to the first wellbore 140 for power generation while other storage zones may remain closed.

Water may be produced from the storage zone 130, leading to expansion of a gas cap 132. In some implementations, water may be produced through the inflow control device (ICD) 118. During production, produced water may travel up the first wellbore 140, through the valve 110 in the open position, and through the valve 106 in the open position. The valve 109 may be in the closed position during a production cycle. The produced water may flow to a turbine 108. The turbine 108 may be a hydroelectric turbine configured to convert the kinetic energy of produced water from the storage zone 130 into mechanical energy. The turbine 108 may be coupled to a hydroelectric generator 145 configured to convert the turbine's mechanical energy into electricity. Thus, stored power within the geomechanical energy storage system 100 may be turned back into usable power. In some implementations, the produced power may be sent back onto the electrical grid. In other implementations, hydraulic pressure from the geomechanical energy storage system 100 may be used for other applications such as powering hydraulic motors, powering other systems directly (e.g., large industrial systems), etc. From the turbine 108, produced fluid is returned to the storage vessel 102. The geomechanical energy storage system 100 may be a closed-loop system with regard to fluid flow through the first wellbore 140.

Traditional subsurface energy storage systems may rely solely on elastic strain energy via deforming of a single storage formation to drive fluid production to the surface 101. However, the geomechanical energy storage system 100 may achieve increased performance compared to these traditional approaches through usage of multiple storage zones 120, 130 and the gas caps 122, 132. During water (or any other incompressible fluid) injection from the first wellbore 140, gas in the fractures 115, for example, is displaced and compressed into the gas cap 122. The compressed gas cap 122 acts as a downhole accumulator which maintains a charge in the form of potential energy. In some implementations, the gas cap 122 may be created via gas injected once throughout the life of the geomechanical energy storage system 100, as the gas within the gas cap 122 is not produced to the surface 101. In some implementations, an accumulator may be defined as a pressure storage reservoir, bladder, etc. in which a fluid (typically an incompressible fluid, although other fluid types may be used) is stored under pressure from an external source. However, other definitions may be possible. With reference to the gas cap 122, the external source of pressure may be provided by one or more subsurface stresses (e.g., overburden stress).

The gas cap 122 may provide the geomechanical energy storage system 100 a higher energy storage capacity than a traditional system of similar size, and the gas cap 122 may allow a higher volume of injected fluid to be stored and thereby produced than traditional approaches. Utilizing the gas cap 122 (or gas cap 132, for example) may also increase the volume of fluid that may be displaced by downhole pressure during a production cycle of the storage zones 120, 130, as the stored charge of the compressed gas aids in displacing injected water during production. Because of this, the gas cap 122 may increase the energy density per fluid volume of injected fluid. Fluid production in the geomechanical energy storage system 100 is driven by both the gas cap 122 and the elastic strain from deforming the storage zone 120.

During production, the gas cap 122 may expand to form the expanded gas cap 132. The expanded gas cap 132 may assist in displacing water through the fractures 125 and out of the storage zone 130. As mentioned above, the gas cap 122 and gas cap 132 are not produced to the surface 101—rather, the gas expands and contracts within the storage zones 120, 130 upon production and injection, respectively. The inflow control device 118 and an inflow control device 114 may help mitigate gas production from the gas caps 122, 132. For example, the inflow control devices 114, 118 (ICDs) may be configured to manage inflow control of fluids during production and mitigate gas inflow into the first wellbore 140. In some implementations, the ICDs 114, 118 may include any one or a combination of inflow control valves (ICVs), electronic inflow control devices (EICDs), autonomous inflow control devices (AICDs), density autonomous inflow control devices (DAICDs), etc. In some implementations, the ICDs 114, 118 may be autonomous devices configured to close upon gas detection. These autonomous devices may be configured to identify liquids and gases based on measured fluid properties such as density, viscosity, etc., although other AICDs may be used. In other implementations, the ICDs 114, 118 may be remotely operated by an operator. During discharge of a storage zone, a water table may move toward the producing well (first wellbore 140) as water is produced to the surface 101. The gas cap 132, for example, may follow the water table. Upon gas breakthrough at the ICDs 114, 118, the ICDs 114, 118 may be configured to close and halt flow into the first wellbore 140. Gas inflow may lower the efficiency of power generation at the turbine 108 and hydroelectric generator 145.

Zonal isolation through usage of the packers 112, 116, 119, 124, 126, and 128 may enable multiple storage zones to be created. For example, although storage zones 120 and 130 are depicted in FIG. 1, a plurality of storage zones may be generated. The energy storage capacity of the geomechanical energy storage system 100 may depend on the length of the producing well (first wellbore 140), the length of the fractures 115, 125 within each storage zone, and the number of storage zones created. Essentially, the energy storage capacity of the geomechanical energy storage system 100 scales with the amount of incompressible fluid that is able to be pumped into the system and later displaced. In horizontal wells, a longer lateral may enable a larger energy storage capacity, although the geomechanical energy storage system 100 may also utilize vertical wellbores and/or a combination of vertical and horizontal wellbores. For example, the first wellbore 140 may be a horizontal well and the second wellbore 150 may be a vertical well used to create the gas cap 122 or gas cap 132. In other implementations, both the first wellbore 140 and the second wellbore 150 may comprise vertical wellbores. In some implementations, the geomechanical energy storage system 100 may use a single wellbore to create the gas cap 122 and for injection/production cycles within the storage zones 120, 130, etc. In any of these configurations, an incompressible fluid may be injected at one or multiple points along the wellbore.

Some traditional approaches may use a single storage formation to store and discharge an incompressible fluid, but this may lead to formation degradation after repeated pressurization and depressurization cycles. By compartmentalizing the storage zones 120 and 130 via the packers 112-128, the geomechanical energy storage system 100 may be more robust. For example, multiple storage zones separated by packers may enable zonal isolation, although other devices may be used. In some implementations, at least one or more of the packers 112-128 may be substituted with a frac plug or any similar device suited for zonal isolation.

In the event one storage zone loses its ability to hold pressure or becomes too permeable, this zone may be shut in. For example, a fracture in one storage zone may overextend from the producing wellbore directly into the gas cap, thereby leading to gas production upon opening of the zone's ICD rather than liquid. This highly-permeable storage zone may be shut-in via its associated ICD while other functional storage zones may continue to operate. Zonal isolation via the packers 112-128 may also assist in spacing the fractures 115 and 125 far enough from one another as to not interfere with or propagate into the neighboring storage zone.

### Example Computer

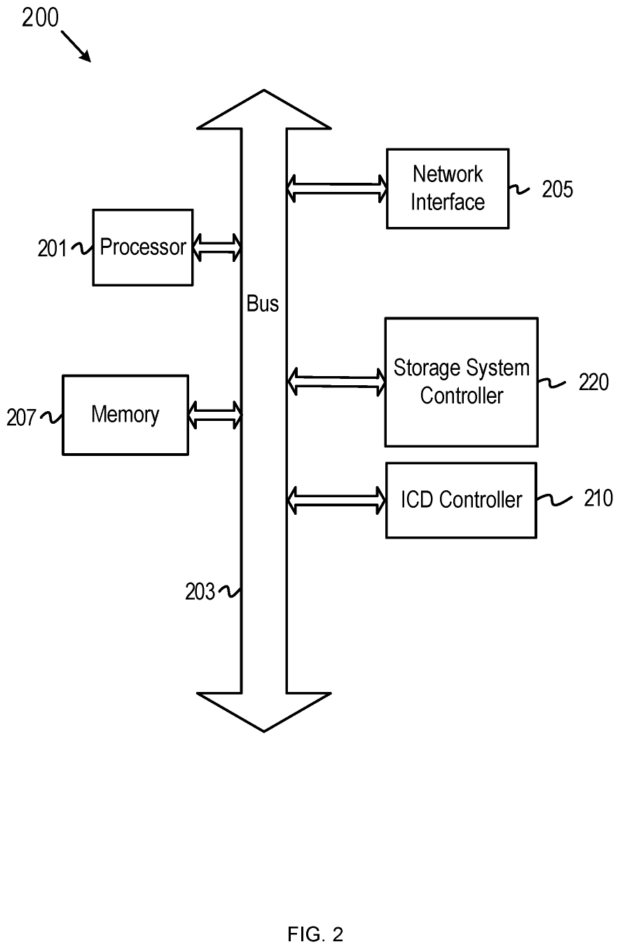

FIG. 2 is a block diagram depicting an example computer 200, according to some implementations. The computer 200 includes a processor 201 (possibly including multiple processors, multiple cores, multiple nodes, and/or implementing multi-threading, etc.). The computer 200 includes memory 207. The memory 207 may be system memory or any one or more of the above already described possible realizations of machine-readable media. The computer 200 also includes a bus 203 and a network interface 205. The computer 200 may communicate via transmissions to and/or from remote devices via the network interface 205 in accordance with a network protocol corresponding to the type of network interface, whether wired or wireless and depending upon the carrying medium. For example, a storage system controller 220 and an ICD controller 210 may be communicatively coupled with a user interface which may be accessed via secure login to a cloud computing service, the user interface may be output to an on-site computer, the user interface may be output to a remote device, etc. In addition, a communication or transmission may involve other layers of a communication protocol and or communication protocol suites (e.g., transmission control protocol, Internet Protocol, user datagram protocol, virtual private network protocols, etc.).

The computer 200 also includes the ICD controller 210 and the storage system controller 220 which may perform, at least in part, the operations described herein. For example, the storage system controller 220 may be configured to perform the above-described operations with reference to the geomechanical energy storage system 100 of FIG. 1 (e.g., injecting a working fluid into the storage zones 120, 130, obtaining pressure measurements via one or more pressure gauges (not shown) placed within the system 100, opening/closing the valves 106, 109, and 110 during injection or production cycles, activating the injection pump 104, etc.). The ICD controller 210 may be configured to open and close the ICDs 114 and 118. In some implementations, the ICD controller 210 may be configured to open and close the ICDs 114, 118 based on whether received sensor measurements exceed set thresholds (i.e., exceeding a threshold prior to gas breakthrough), although other configurations may be possible. In other implementations, the ICD controller 210 may allow for personnel to remotely access and control the ICDs 114, 118, etc. The ICD controller 210 and the storage system controller 220 may be in communication.

While the ICD controller 210 may include functionality to control the ICDs 114 and 118, some implementations of the ICDs 114, 118 may include non-computer controlled AICDs, DAICDs, etc. which may autonomously restrict the production of gas. Some implementations of the AICDs and/or DAICDs may include functionality therein to autonomously restrict gas production upon gas reaching the AICD, DAICD, etc. based on a fluid property of the gas. The fluid property may be measured by the DAICD, the AICD, a sensor proximate to the flow control device, etc. The fluid property may typically include the density of the gas or the viscosity of the gas, although other fluid properties may be used.

Any one of the previously described functionalities may be partially (or entirely) implemented in hardware and/or on the processor 201. For example, the functionality may be implemented with an application specific integrated circuit, in logic implemented in the processor 201, in a co-processor on a peripheral device or card, etc. Further, realizations may include fewer or additional components not illustrated in FIG. 2 (e.g., video cards, audio cards, additional network interfaces, peripheral devices, etc.). The processor 201 and the network interface 205 are coupled to the bus 203. Although illustrated as being coupled to the bus 203, the memory 207 may be coupled to the processor 201.

### Example Method of Operations

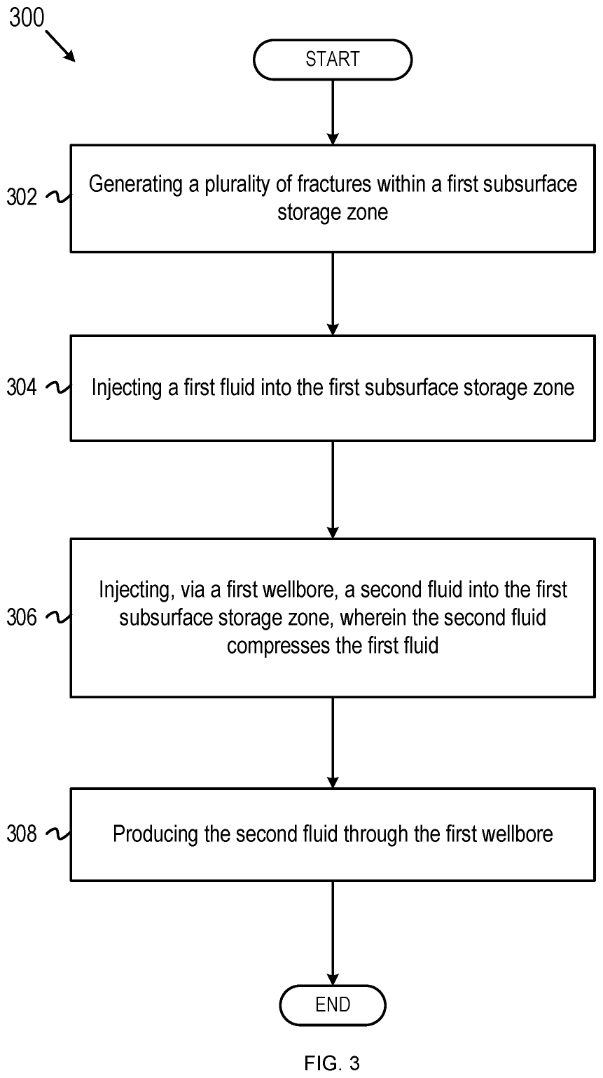

FIG. 3 is block diagram depicting a method 300 for geomechanical energy storage using at least one wellbore, according to some implementations. The operations of the method 300 are described with reference to FIGS. 1-2. Flow of the method 300 begins at block 302.

At block 302, the method 300 includes generating a plurality of fractures within a first subsurface storage zone. For example, the fractures 115 may be generated within the storage zone 120 via hydraulic fracturing. The spacing of the fractures, concentration of the fractures, and other aspects of fracture design may depend on the desired specifications of the resulting storage system. Production enhancement operations (refracturing, removing wellbore skin, etc.) may be used to enhance the fracture network within each storage zone. In some implementations, the storage zone 120 may be sufficiently permeable to store fluid without creating the fractures 115. Flow progresses to block 304.

At block 304, the method 300 includes injecting a first fluid into the first subsurface storage zone. For example, a gas may be injected into the storage zone 120 via the second wellbore 150 to form the gas cap 122. This may form the downhole accumulator used to hold a charge when the storage zone 120 is pressurized. Flow progresses to block 306.

At block 306, the method 300 includes injecting, via a first wellbore, a second fluid into the first subsurface storage zone, wherein the second fluid compresses the first fluid. For example, an incompressible fluid such as water may be injected into the storage zone 120 via the first wellbore 140. The incompressible fluid may navigate through the storage zone 120 via the fractures 115 and compress the gas within the gas cap 122. Flow progresses to block 308.

At block 308, the method 300 includes producing the second fluid through the first wellbore. For example, at a higher power price point, the ICD 114 may open to allow water to flow uphole via the first wellbore 140. Elastic strain energy from the expanded storage zone and an expansion of the gas cap 122 may propel the water out of the storage zone 120. The water may pass through the turbine 108 used to drive the hydroelectric generator 145. The hydroelectric generator 145 may generate electrical power, thus reclaiming the power used to pump the water into the storage zone 120 at the lower price point. Flow of the method 300 ceases.

While the aspects of the disclosure are described with reference to various implementations and exploitations, it will be understood that these aspects are illustrative and that the scope of the claims is not limited to them. In general, techniques for geomechanical energy storage as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

### Example Implementations

Implementation #1: A system configured for subsurface energy storage, the system comprising: at least a first wellbore drilled into one or more subsurface formations; a first downhole accumulator having a first fluid; and a first subsurface storage zone including a second fluid and the first downhole accumulator.
Implementation #2: The system of Implementation 1, further comprising: a pump configured to pump the second fluid into the first subsurface storage zone.
Implementation #3: The system of any one or more of Implementations 1 or 2, wherein the first downhole accumulator comprises an artificial gas cap configured to displace the second fluid in the first subsurface storage zone.
Implementation #4: The system of any one or more of Implementations 1-3, further comprising: a second wellbore, wherein the first subsurface storage zone includes a first plurality of fractures, and wherein the first wellbore and the second wellbore are hydraulically coupled to the first subsurface storage zone via the first plurality of fractures.
Implementation #5: The system of any one or more of Implementations 1-4, wherein the first fluid and the second fluid are hydraulically communicable via the first plurality of fractures.
Implementation #6: The system of any one or more of Implementations 1-5, further comprising: an inflow control device coupled to the first wellbore and positioned within the first subsurface storage zone.
Implementation #7: The system of any one or more of Implementations 1-6, wherein the inflow control device is configured to restrict a flow of the first fluid into the first wellbore.
Implementation #8: The system of any one or more of Implementations 1-7, further comprising: a second subsurface storage zone including the second fluid, a second plurality of fractures, and a second downhole accumulator; and a first pair of packers configured to isolate the first subsurface storage zone from the second subsurface storage zone.
Implementation #9: The system of any one or more of Implementations 1-8, wherein the first wellbore and the second wellbore are hydraulically communicable via the second plurality of fractures.
Implementation #10: The system of any one or more of Implementations 1-9, further comprising: a turbine configured to receive the second fluid; a generator coupled to the turbine and configured to generate power; and a surface storage vessel configured to hold a quantity of the second fluid prior to being pumped into the first subsurface storage zone.
Implementation #11: A method comprising: injecting a first fluid into a first subsurface storage zone; injecting, via a first wellbore, a second fluid into the first subsurface storage zone, wherein the second fluid compresses the first fluid; and producing the second fluid through the first wellbore.
Implementation #12: The method of Implementation 11, further comprising: generating a first plurality of fractures within the first subsurface storage zone; and injecting the first fluid into the first subsurface storage zone to generate a downhole accumulator, wherein the downhole accumulator includes the first fluid.
Implementation #13: The method of any one or more of Implementations 11 or 12, wherein injecting the first fluid into the first subsurface storage zone to generate the downhole accumulator comprises injecting the first fluid into the first subsurface storage zone via the first wellbore.
Implementation #14: The method of any one or more of Implementations 11-13, wherein injecting the first fluid into the first subsurface storage zone to generate the downhole accumulator comprises injecting the first fluid into the first subsurface storage zone via a second wellbore, and wherein the downhole accumulator comprises an artificial gas cap.
Implementation #15: The method of any one or more of Implementations 11-14, further comprising: injecting, at a first power price, the second fluid into the first subsurface storage zone; and producing, via the second wellbore and at a second, higher power price, the second fluid from the first subsurface storage zone.
Implementation #16: The method of any one or more of Implementations 11-15, further comprising: generating a second plurality of fractures within a second subsurface storage zone; injecting the first fluid into the second subsurface storage zone; and injecting, via the first wellbore, the second fluid into the second subsurface storage zone, wherein the second fluid compresses the first fluid.
Implementation #17: The method of any one or more of Implementations 11-16, further comprising: isolating, via a first pair of packers, the first subsurface storage zone from the second subsurface storage zone.
Implementation #18: The method of any one or more of Implementations 11-17, further comprising: controlling, via a first inflow control device coupled to the first wellbore within the first subsurface storage zone, a flow of the second fluid into the first wellbore; and halting, via the first inflow control device, a flow of the first fluid into the first wellbore.
Implementation #19: The method of any one or more of Implementations 11-18, further comprising: controlling, via a second inflow control device coupled to the first wellbore within the second subsurface storage zone, the flow of the second fluid into the first wellbore; and selectively producing the second fluid from the first subsurface storage zone and the second subsurface storage zone via the first inflow control device and the second inflow control device.
Implementation #20: The method of any one or more of Implementations 11-19, wherein producing the second fluid through the first wellbore comprises: producing, via the first wellbore, the second fluid from at least one of the first subsurface storage zone and the second subsurface storage zone, wherein a downhole pressure propels the second fluid towards a surface proximate to the first wellbore; receiving, via a turbine at the surface, the second fluid; and generating power via a generator coupled to the turbine.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” may be infringed with only one of the listed items, multiple of the listed items, and one or more of the items in the list and another item not listed. As an example, “at least one of: a, b, or c” is intended to cover: a, b, c, a-b, a-c, b-c, and a-b-c.

As used herein, the term “or” is inclusive unless otherwise explicitly noted. Thus, the phrase “at least one of A, B, or C” is satisfied by any element from the set {A, B, C} or any combination thereof, including multiples of any element. The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described throughout. Whether such functionality is implemented in hardware or software depends upon the particular application and design constraints imposed on the overall system.

The hardware and data processing apparatus used to implement the various illustrative logics, logical blocks, modules and circuits described in connection with the implementations disclosed herein may be implemented or performed with a general purpose single- or multi-chip processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor or any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more implementations, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, e.g., one or more modules of computer program instructions stored on a computer storage media for execution by, or to control the operation of, a computing device.

If implemented in software, the functions may be stored on or transmitted over as one or more instructions or code on a computer-readable medium. The processes of a method or algorithm disclosed herein may be implemented in a processor-executable instructions which may reside on a computer-readable medium. Computer-readable media includes both computer storage media and communication media including any medium that may be enabled to transfer a computer program from one place to another. Storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-Ray™ disc where disks usually reproduce data magnetically, while discs reproduce data optically with lasers. Combinations also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable sub-combination. Moreover, although features may be described as acting in certain combinations and even initially claimed as such, one or more features from a claimed combination may in some cases be excised from the combination, and the claimed combination may be directed to a sub-combination or variation of a sub-combination.

While operations are depicted in the drawings in a particular order, this should not be understood as requiring that such operations be performed in the particular order shown or in sequential order, or that all illustrated operations be performed, to achieve desirable results. Further, the drawings may schematically depict one more example process in the form of a flow diagram. However, some operations may be omitted and/or other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described should not be understood as requiring such separation in all implementations, and the described program components and systems may generally be integrated together in a single software product or packaged into multiple software products. Additionally, other implementations are within the scope of the following claims. In some cases, the actions recited in the claims may be performed in a different order and still achieve desirable results.

Unless otherwise specified, use of the terms “up,” “upper,” “upward,” “uphole,” “upstream,” or other like terms shall be construed as generally away from the bottom, terminal end of a well; likewise, use of the terms “down,” “lower,” “downward,” “downhole,” or other like terms shall be construed as generally toward the bottom, terminal end of the well, regardless of the wellbore orientation. Use of any one or more of the foregoing terms shall not be construed as denoting positions along a perfectly vertical axis. In some instances, a part near the end of the well can be horizontal or even slightly directed upwards. Unless otherwise specified, use of the terms “subsurface formation” or “subterranean formation” shall be construed as encompassing both areas below exposed earth and areas below earth covered by water such as ocean or fresh water.

1-10. (canceled)

11. A method comprising:
forming a subsurface energy storage system including at least a first subsurface storage zone and a second subsurface storage zone, wherein the first subsurface storage zone and the second subsurface storage zone are coupled via a first wellbore extending from surface;
injecting a first fluid into the first subsurface storage zone;
injecting, via the first wellbore, a second fluid into at least the first subsurface storage zone, wherein the second fluid compresses the first fluid; and
producing the second fluid through the first wellbore.

12. The method of claim 11, further comprising:
generating a first plurality of fractures within the first subsurface storage zone; and
injecting the first fluid into the first subsurface storage zone to generate a downhole accumulator, wherein the downhole accumulator includes the first fluid.

13. The method of claim 12, wherein injecting the first fluid into the first subsurface storage zone to generate the downhole accumulator comprises injecting the first fluid into the first subsurface storage zone via the first wellbore.

14. The method of claim 12, wherein injecting the first fluid into the first subsurface storage zone to generate the downhole accumulator comprises injecting the first fluid into the first subsurface storage zone via a second wellbore, and wherein the downhole accumulator comprises an artificial gas cap.

15. The method of claim 14, further comprising:
injecting, at a first power price, the second fluid into the first subsurface storage zone; and
producing, via the second wellbore and at a second, higher power price, the second fluid from the first subsurface storage zone.

16. The method of claim 12, further comprising:
generating a second plurality of fractures within the second subsurface storage zone;
injecting the first fluid into the second subsurface storage zone; and
injecting, via the first wellbore, the second fluid into the second subsurface storage zone, wherein the second fluid compresses the first fluid.

17. The method of claim 11, further comprising:
isolating, via a first pair of packers, the first subsurface storage zone from the second subsurface storage zone.

18. The method of claim 11, further comprising:
controlling, via a first inflow control device coupled to the first wellbore within the first subsurface storage zone, a flow of the second fluid into the first wellbore; and
halting, via the first inflow control device, a flow of the first fluid into the first wellbore.

19. The method of claim 18, further comprising:
controlling, via a second inflow control device coupled to the first wellbore within the second subsurface storage zone, the flow of the second fluid into the first wellbore; and
selectively producing the second fluid from the first subsurface storage zone and the second subsurface storage zone via the first inflow control device and the second inflow control device.

20. The method of claim 11, wherein producing the second fluid through the first wellbore comprises:
producing, via the first wellbore, the second fluid from at least one of the first subsurface storage zone and the second subsurface storage zone, wherein a downhole pressure propels the second fluid towards the surface;
receiving, via a turbine at the surface, the second fluid; and
generating power via a generator coupled to the turbine.
